(19) United States
(12) Patent Application Publication
(10) Pub. No.: US 2010/0151401 A1
(43) Pub. Date: Jun. 17, 2010

(54) ORTHODONTIC IMPLANT CAP AND ORTHODONTIC TREATMENT ASSEMBLY INCLUDING SAME

(75) Inventors: Nicole Marie Scheffler, Boone, NC (US); Jefferson Sabilla, Ontario, CA (US)

Correspondence Address: WOOD, HERRON & EVANS, LLP, 2700 CAREW TOWER, 441 VINE STREET, CINCINNATI, OH, 45202, US

(73) Assignee: ORMCO CORPORATION, Orange, CA (US)

(21) Appl. No.: 12/444,184

(22) PCT Filed: Oct. 10, 2007
(86) PCT No.: PCT/US07/80880

§ 371 Date: Jan. 25, 2010

Related U.S. Application Data
(60) Provisional application No. 60/850,624, filed on Oct. 10, 2006.

(51) Int. Cl. A61C 7/00

(52) U.S. Cl. 433/2

(57) ABSTRACT

A cap (14) for an orthodontic implant (12) generally comprises a body (16) and a receiving member (20) coupled to the body. The body includes an opening (32) and a cavity (18) configured to receive a portion of the orthodontic implant (12), with the opening (32) being non-circular. The receiving member (20) is configured to retain a portion of an orthodontic component so that when the orthodontic implant (12) is received in the cavity of the body, forces may be transmitted between the orthodontic component and the orthodontic implant (12) via the cap (14).

### PRIORITY CLAIM

This application claims the benefit of U.S. Provisional Patent Application Ser. No. 60/850,624, filed Oct. 10, 2006 and entitled “ORTHODONTIC DEVICES, IMPLANTS AND RELATED APPARATUS,” the disclosure of which is expressly incorporated by reference herein in its entirety.

### RELATED APPLICATION

This application is also generally related to commonly owned, co-pending PCT International Application No. ______ (Attorney Docket No. ORM-313WO10), entitled “CORRECTOR ASSEMBLY WITH A TELESCOPABLE PORTION, A CRIMPABLE PORTION, AND AN ENGAGING PORTION, AND A RELATED METHOD,” which is filed concurrently herewith and expressly incorporated by reference herein in its entirety.

### TECHNICAL FIELD

The present invention relates generally to orthodontics, and more particularly to a cap for an orthodontic implant and an orthodontic treatment assembly including the same.

### BACKGROUND

Orthodontic treatment involves movement of malpositioned teeth to orthodontically correct positions. During treatment, small orthodontic appliances known as brackets are often connected to anterior, bicuspid, and molar teeth, and an archwire is placed in a slot of each bracket. The archwire forms a track to guide movement of the brackets and the associated teeth to desired positions. Typically, the ends of the archwire are held by appliances known as buccal tubes that are secured to a patient's molar teeth. The brackets, archwires, and buccal tubes are commonly referred to as “braces.”

To effect the desired orthodontic treatment, one or more orthodontic implants may be used in combination with a set of braces. For example, a miniscrew or other anchor may be secured to one of the patient's dental arches at a first location in the patient's mouth. A ligature or biasing member, such as a spring or elastomeric band, is then coupled the miniscrew and secured to the archwire or one of the brackets at a second location in the patient's mouth. The ligature is placed under tension so that a force is exerted on the archwire to help reposition teeth secured to nearby brackets.

Current devices and methods for effecting orthodontic treatment in the manner described above leave room for improvement. Thus, an orthodontic treatment assembly that effectively accommodates couples an archwire, bracket, or any other orthodontic component to an orthodontic implant (such as a miniscrew) is highly desirable.

### SUMMARY

A cap for an orthodontic implant is provided, along with an orthodontic treatment assembly incorporating such a cap. The orthodontic implant may be any structure secured in a patient's mouth to help effect a particular orthodontic treatment.

In one embodiment, the cap comprises a body and a receiving member coupled to the body. The body has an opening and a cavity configured to receive a portion of the orthodontic implant, with the opening having a first radial dimension and a second radial dimension less than the first radial dimension. The receiving member is configured to retain a portion of an orthodontic component, such as an archwire or coil spring. The receiving member may include, for example, a rectangular tube defining a channel for receiving an archwire.

In another embodiment, the receiving member comprises a base coupled to the body and a cover pivotally coupled to the base. A channel for receiving the orthodontic component extends across a top surface of the base, which may be integrally formed with the body or separately attached to the body. The cover is movable between a first position in which it overlies the channel and a second position in which it does not overlie the channel.

In yet another embodiment, an orthodontic treatment assembly generally comprises an orthodontic implant and a cap. The orthodontic implant includes a head and a shaft coupled to the head. The cap includes a body having an opening and a cavity configured to receive the head of the orthodontic implant, with the opening having a first radial dimension and a second radial dimension less than said first radial dimension. The cap also includes a receiving member coupled to the body and configured to retain a portion of an orthodontic component.

### BRIEF DESCRIPTION OF THE DRAWINGS

The accompanying drawings, which are incorporated in and constitute a part of this specification, illustrate exemplary embodiments of the invention.

FIG. 1 is an exploded perspective view of an orthodontic treatment assembly including a cap according to one embodiment.

FIGS. 2A and 2B are perspective views illustrating a cover the cap of FIG. 1 in a first position and a second position.

FIG. 3 is a cross-sectional view of the orthodontic treatment assembly of FIG. 1 with the cover in the first position.

FIG. 4 is a perspective view of an orthodontic treatment assembly including a cap according to another embodiment.

FIG. 5 is a cross-sectional view of the orthodontic treatment assembly of FIG. 4.

FIG. 6 is a perspective view of an orthodontic treatment assembly including a cap according to yet another embodiment.

### DETAILED DESCRIPTION

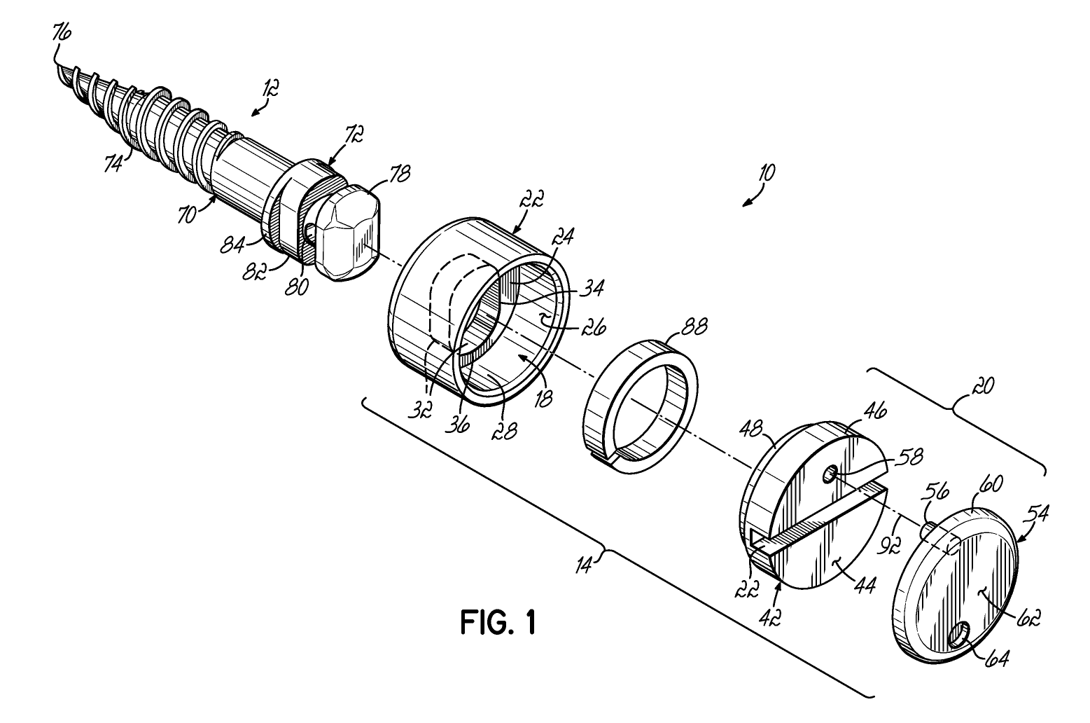

With reference to FIGS. 1-3, one embodiment of an orthodontic treatment assembly 10 is shown. The orthodontic treatment assembly 10 generally comprises an orthodontic implant 12, such as a miniscrew, and a cap 14 (sometimes referred to as an “overcap”) configured to fit over a portion of the orthodontic implant 12. Orthodontic implants particularly suited for use in the present invention are disclosed in co-pending PCT International Application No. ______, filed Oct. 10, 2007, entitled “ORTHODONTIC IMPLANTS,” which is expressly incorporated by reference herein in its entirety. The cap 14 includes a body 16 defining a cavity 18 and a receiving member 20 defining a channel 22. As will be described in greater detail below, the channel 22 is configured to receive an orthodontic component (such as an archwire, etc.) so that the cap 14 may be used to position the orthodontic implant 12 relative to the orthodontic component to effect a desired treatment.

In one embodiment, the body 16 is substantially cylindrical with the cavity 18 extending therethrough. A disc-shaped member 24 extending from an inner wall 26 of the body 16 divides the cavity 18 into a first section 28 and a second section 30 (FIG. 3). The disc-shaped member 24 includes an opening 32 having a non-circular configuration. For example, the opening 32 may have both a first radial dimension and a second radial dimension, with the second radial dimension being less than the first radial dimension. In the exemplary embodiment shown, the opening 32 includes a straight section 34 interconnecting rounded end sections 36, 38 so as to have a substantially oval configuration, although the invention is not so limited.

The receiving member 20 may include a base 42 having a top surface 44 across which the channel 22 extends. The channel 22 is formed in a top section 46 of the base 42, which also includes a reduced diameter section 48 projecting from a bottom surface 50 of the top section 46. Such an arrangement enables the base 42 to be easily coupled to the body 16. For example, the reduced diameter section 48 may be sized to create a slight interference fit with the first section 28 of the cavity 18. This allows the base 42 to be press-fit or snapped onto the body 16. However, those skilled in the art will appreciate that a wide variety of alternative techniques may be also be used to couple the base 42 to the body 16. For example, the base 42 may be integrally formed with the body 16 so as to be part of a unitary structure. Alternatively, the base 42 may be a separate component adhered, welded, threaded, fastened, or otherwise secured to the body 16.

A cover 54 is pivotally coupled to the base 42 by a pivot pin 56 received in a pivot hole 58 provided in the top section 46. The cover 54 includes a bottom surface 60 that confronts the top surface 44 of the base 42 when the receiving member 20 is assembled and a top surface 62 opposite the bottom surface 60. As will be described in greater detail below, the cover 54 is movable between a first position in which it overlies or covers the channel 22 and a second position in which it does not overlie or cover the channel 22. An engagement structure, such as small bore or depression 64, may be provided in the top surface 62 so that the cover 54 may be engaged by a tool (not shown) and manipulated to move in between the first and second positions.

Still referring to FIGS. 1-3, the orthodontic implant 12 includes a shaft 70 and a head 72 coupled to the shaft 70. Although the particular orthodontic implant shown is a miniscrew with the shaft 70 having a threaded portion 74 that tapers to a tip 76, it will be appreciated that other types of orthodontic implants may be used in the orthodontic treatment assembly. The head 72 defines an upper section 78, a middle section 80, and a lower section 82 that may have different cross-sectional dimensions and/or configurations. For example, the upper section 78 may have a first cross-sectional dimension and the middle section 80 may have a second cross-sectional dimension less than the first cross-sectional dimension. Additionally, the upper section 78 may have a non-circular cross-sectional configuration substantially corresponding to the shape of the opening 32 in the disc-shaped member 24, whereas the middle section 80 may have a substantially circular cross-sectional configuration. The cross-sectional dimensions and configuration of the lower section 82 may be substantially the same or different than the upper section 78 or middle section 80.

To assemble the cap 14 onto the orthodontic implant 12, the body 16 of the cap 14 is positioned so that the opening 32 is aligned with the upper section 78 of the head 72. This alignment allows an individual to push the body 16 onto the head 72 so that the upper section 78 extends through the opening 32 and into the first section 28 of the cavity 18. In some embodiments, the head 72 may further include a ledge 84 below the lower section 82, with the ledge 84 having a radial dimension larger than a radial dimension of the second section 30 of the cavity 18. Such a ledge 84 limits how far the body 16 may be pushed onto the head 72 (or, in other words, how far the head 72 may be advanced into the cavity 18).

Once pushed onto the head 72, the body 16 is rotated relative to the orthodontic implant 12 so that the opening 32 is no longer aligned with the upper section 78. As a result, portions of the upper section 78 overlap portions of the disc-shaped member 24. For example, a wider aspect (i.e., the first radial dimension) of the upper section 78 may become aligned with a narrow aspect (i.e., the second radial dimension) of the opening 32. This arrangement prevents the body 16 from being pulled off the head 72 (or the head 72 being pulled out from the body 16).

A friction element, such as a C-shaped spring 88, may be clamped or otherwise secured to the upper section 78 of the head 72 before or after the body 16 is rotated. The C-shaped spring 88 may be sized so that a friction fit is created between the inner wall 26 of the body 16 and the head 72 of the orthodontic implant 12. Indeed, the friction element may be any structure configured to lock the cap 14 into place once the body 16 has been properly positioned onto the head 72. Alternatively, the friction element may allow the body 16 to freely rotate relative to the orthodontic implant 12 even when assembled. FIG. 3 illustrates the orthodontic treatment assembly 10 with the C-shaped spring 88 received around the head 72 within the first section 28 of the cavity 18. As shown in FIG. 3, the C-shaped spring 88 may be sized so that a slight gap 90 exists between the C-shaped spring 88 and the inner wall 26. This allows the cap 14 to continue to rotate relative to head 72.

At some point during the assembly process, the cover 54 of the receiving member 20 is pivotally coupled to the base 42. This may be accomplished, for example, by inserting the pivot pin 56 into the pivot hole 58, which may be configured to retain the pivot pin 56 therein. In alternative embodiments, the base 42 may be provided with a pivot pin (not shown) and the cover 54 with a pivot hole (not shown). The cover 54 rotates relative to the base 42 about a pivot axis 92 defined by the pivot pin 56 when assembled.

The receiving member 20 is also coupled to the body 16 during the assembly process. As shown in FIG. 3, the reduced diameter section 48 of the base 42 may create an interference fit with the inner wall 26 of the cavity 18 such that the base 42 need only be press fit onto the body 16. Again, however, those skilled in the art will appreciate that the assembly process described above is merely exemplary in nature and corresponds to the particular embodiment shown. Threading, adhering, and fastening techniques could alternatively or additionally be used to secure the base 42 to the body 16. Furthermore, the receiving member 20 may alternatively be integrally formed with the body 16 such that no friction element is inserted into the first section 28 of the cavity 18 and no separate step is required to secure the base 42 to the body 16.

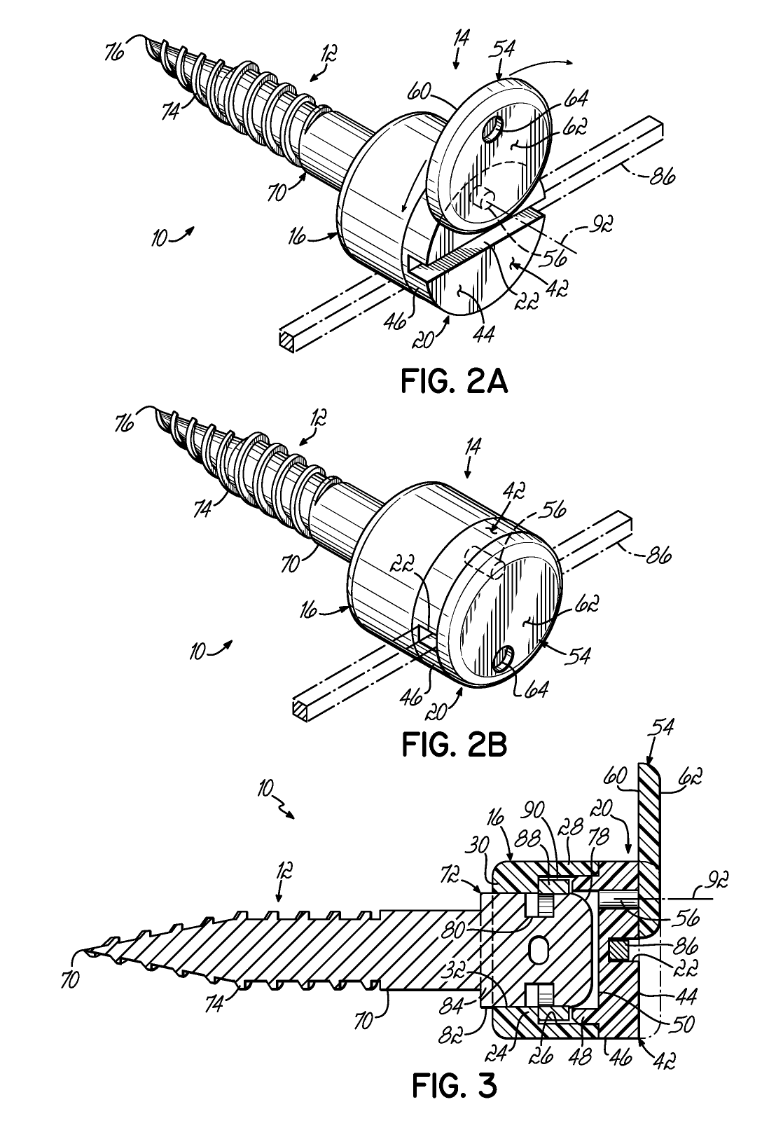

In use, the cover 54 of the receiving member 20 is first moved to the second position in which it does not overlie the channel 22 in the base 42, as shown in FIG. 2A. An orthodontic component, such as an archwire 96, may then be received in the channel 22. If the cap 14 is configured to freely rotate relative to the orthodontic implant 12, the orientation of the channel 22 relative to the archwire 96 may be adjusted without adjusting the position of the archwire 96. This may be particularly advantageous when the archwire 96 is secured at other nearby locations in a patient's mouth and difficult to manipulate. If the cap 14 is not configured to freely rotate relative to the orthodontic implant 12, the orthodontic treatment assembly 10 and/or the archwire 96 are adjusted until the archwire 96 is received in the channel 22.

Rather than using ligatures (not shown) to couple the archwire 86 to the orthodontic treatment assembly 10, the cover 54 may be moved back to the first position in which it overlies the channel 22. As shown in FIG. 2B, the cover 54 retains the cap 14 to the archwire 96 by preventing the archwire 96 from being displaced from the channel 22 through the top surface 44. The pivot pin 56 may cooperate with the pivot hole 58 so that the cover 54 does not freely rotate back to the second position. Instead, sufficient force must be applied to overcome any resistance created by such cooperation and any friction between the bottom surface 60 of the cover 54 and the top surface 44 of the base 42. Thus, when the cover 54 is in the first position and retaining the cap 14 to the archwire 96, forces may be transferred from the archwire 96 to the orthodontic treatment assembly 10, or vice-versa, to help reposition teeth or effect other orthodontic treatment. Although not required, conventional ligatures (not shown) may still be used in combination with the cap 14 described above to couple the orthodontic treatment assembly 10 to the archwire 96 or another orthodontic component.

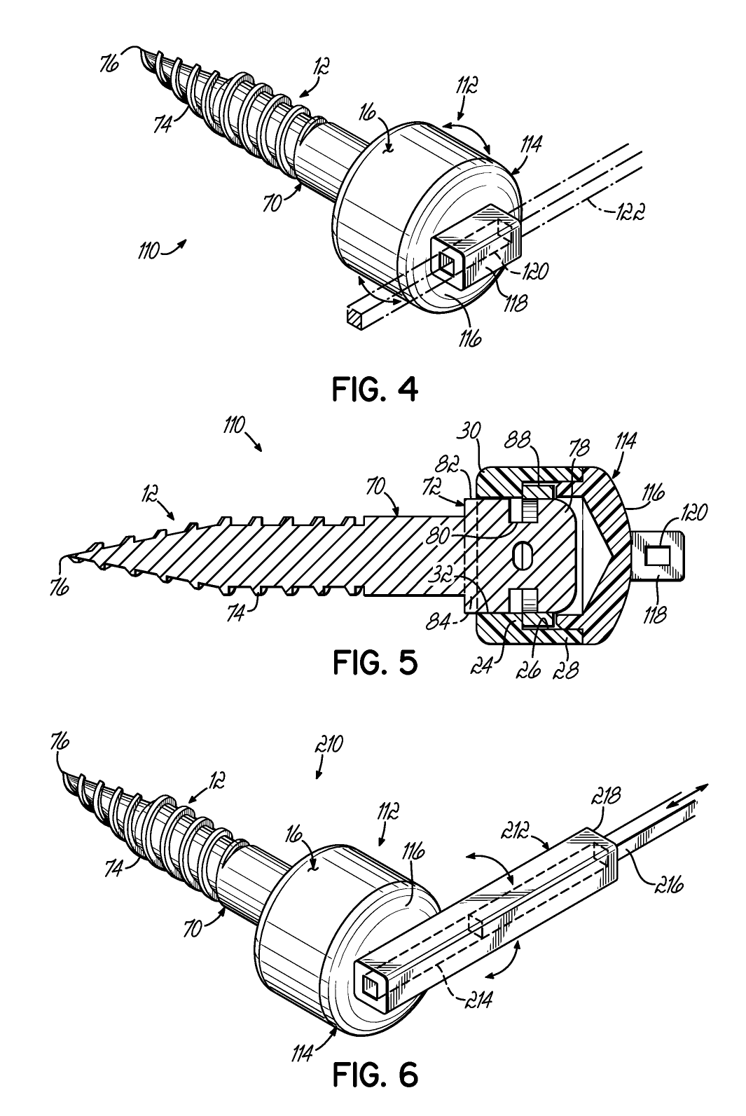

FIGS. 4 and 5 illustrate an orthodontic treatment assembly 110 according to an alternative embodiment. Because the orthodontic treatment assembly 110 includes many of the same components as the orthodontic treatment assembly 10, like reference numbers are used to refer to like structure from FIGS. 1-3. Additionally, only the differences between the orthodontic treatment assembly 10 and the orthodontic treatment assembly 110 will be described below.

The orthodontic treatment assembly 110 includes a cap 112 having the base 42 and a receiving member 114. The receiving member 114 includes a base 116 coupled to the body 16 in the same manner as the base 42 (FIGS. 1-3). However, rather than defining a channel in the base 116, the receiving member 114 further includes a rectangular tube 118 coupled to the base 116. The rectangular tube 118 may be integrally formed with the base 116 or separately formed and subsequently secured to the base 116 by welding, fastening, or any other suitable technique. Additionally, the rectangular tube 118 defines a channel 120 configured to receive an orthodontic component (schematically shown at 122), such as an end of an archwire, retraction arch, coil spring, or other orthodontic force-imparting device. The orthodontic component 122 may simply extend through the channel 120, or the rectangular tube 118 may be crimped at a location with a crimping tool (not shown) to secure the cap 112 relative to the orthodontic component 122. If desired, conventional ligatures (not shown) could still be used in combination with the rectangular tube 118.

FIG. 6 illustrates an orthodontic treatment assembly 210 according to yet another embodiment. The orthodontic treatment assembly 210 includes many of the same components as the orthodontic treatment assembly 110. Accordingly, like reference numbers will once again be used to refer to like structure from the previous embodiments and only the differences will be described below.

As shown in FIG. 6, the receiving member 114 includes an elongated rectangular tube 212 coupled to the base 116. The elongated rectangular tube 212 defines an elongated channel 214 for receiving an orthodontic component 216. Thus, the elongated rectangular tube 212 is similar to the rectangular tube 118 (FIGS. 4 and 5), but includes a distal end 218 that extends an additional distance from the base 116. To this end, like the rectangular tube 118, the elongated rectangular tube 212 may be crimped or otherwise secured to an end of an archwire, retraction arch, coil spring, or other orthodontic force-imparting device.

In one embodiment, the orthodontic component 216 is a guide wire extending from the orthodontic treatment assembly 210 to another orthodontic implant or orthodontic component (not shown), such as a tube crimped onto an archwire. A coil spring (not shown) may be placed in compression between the distal end 218 of the elongated rectangular tube 212 and the other orthodontic implant or orthodontic component. When arranged in such a manner, the forces exerted by the coil spring tend to push the orthodontic treatment assembly 210 away from the other orthodontic implant or orthodontic component. The additional length of the elongated rectangular tube 212 serves to hide and/or protect the additional guide wire length needed to accommodate any change in position of the orthodontic treatment assembly 210 relative to the other orthodontic implant or orthodontic component as treatment is effected over time.

While the invention has been illustrated by the description of one or more embodiments thereof, and while the embodiments have been described in considerable detail, they are not intended to restrict or in any way limit the scope of the appended claims to such detail. Additional advantages and modifications will readily appear to those skilled in the art. For example, although the receiving members described above include channels for receiving an orthodontic component, the receiving members may alternatively or additionally include structure to which orthodontic components may be secured or retained. One example of such structure is an eyelet (not shown) for retaining an end of a coil spring or the like. The invention in its broader aspects is therefore not limited to the specific details, representative apparatus and methods, and illustrative examples shown and described. Accordingly, departures may be made from such details without departing from the scope or spirit of the general inventive concept.

What is claimed is:

1. A cap for an orthodontic implant, comprising:
a body having an opening and a cavity configured to receive a portion of the orthodontic implant, said opening having a first radial dimension and a second radial dimension less than said first radial dimension; and
a receiving member coupled to said body and configured to retain a portion of an orthodontic component.

2. The cap of claim 1 wherein said body further includes a disc-shaped member dividing said cavity into a first section and a second section, said opening of said body being provided in said disc-shaped member.

3. The cap of claim 2, further comprising:
a friction element configured to be received in said first section of said cavity around the orthodontic implant.

4. The cap of claim 1 wherein said cavity extends through said body and said receiving member further comprises a base coupled to said body.

5. The cap of claim 4 wherein said receiving member further comprises a rectangular tube coupled to said base, said rectangular tube defining a channel configured to receive an orthodontic component.

6. The cap of claim 1 wherein at least a portion of said receiving member is integrally formed with said body.

7. The cap of claim 1 wherein said body is configured to rotate relative to the orthodontic implant when the orthodontic implant is received in said cavity.

8. A cap for an orthodontic implant, comprising:
a body having an opening and a cavity configured to receive a portion of the orthodontic implant, said opening having a first radial dimension and a second radial dimension less than said first radial dimension;
a receiving member, comprising:
a base coupled to said body, said base having a top surface and defining a channel extending across said top surface, said channel configured to receive an orthodontic component; and
a cover pivotally coupled to said base and movable from a first position in which said cover overlies said channel and a second position in which said cover does not overlie said channel.

9. The cap of claim 8 wherein said body further includes a disc-shaped member dividing said cavity into a first section and a second section, said opening of said body being provided in said disc-shaped member.

10. The cap of claim 9, further comprising:
a friction element configured to be received in said first section of said cavity around the orthodontic implant.

11. The cap of claim 8 wherein said base of said receiving member is integrally formed with said body.

12. The cap of claim 8 wherein said body is configured to rotate relative to the orthodontic implant when the orthodontic implant is received in said cavity.

13. An orthodontic treatment assembly, comprising:
an orthodontic implant having a head and a shaft coupled to said head; and
a cap, comprising:
a body having an opening and a cavity configured to receive said head of said orthodontic implant, said opening having a first radial dimension and a second radial dimension less than said first radial dimension; and
a receiving member coupled to said body and configured to retain a portion of an orthodontic component.

14. The orthodontic treatment assembly of claim 13 wherein said body further includes a disc-shaped member dividing said cavity into a first section and a second section, said opening of said body being provided in said disc-shaped member.

15. The orthodontic treatment assembly of claim 14 wherein said head includes an upper section, a middle section, and a lower section, said upper section having a first cross-sectional dimension and said middle section having a second cross-sectional dimension less than said first cross-sectional dimension.

16. The orthodontic treatment assembly of claim 15 wherein said upper section has a non-circular cross-sectional configuration substantially corresponding to the shape of said opening.

17. The orthodontic treatment assembly of claim 15, further comprising:
a friction element received in said first section of said cavity around said upper section of said head.

18. The orthodontic treatment assembly of claim 15 wherein said cavity extends through said body and said receiving member further comprises:
a base coupled to said body; and
a rectangular tube coupled to said base, said rectangular tube defining a channel configured to receive an orthodontic component.

19. The orthodontic treatment assembly of claim 15 wherein said receiving member comprises:
a base coupled to said body, said base having a top surface and defining a channel extending across said top surface, said channel configured to receive an orthodontic component; and
a cover pivotally coupled to said base and movable from a first position in which said cover overlies said channel and a second position in which said cover does not overlie said channel.

20. The orthodontic treatment assembly of claim 15 wherein at least a portion of said receiving member is integrally formed with said body.
